(19) United States
(12) Patent Application Publication
(10) Pub. No.: US 2007/0113204 A1
(43) Pub. Date: May 17, 2007

(54) Method of displaying menus in mobile telephone

(75) Inventors: Yong Tae Son, Kyongsangbuk-do (KR); Chang Hun Choi, Kyonggi-do (KR)

Correspondence Address: KED & ASSOCIATES, LLP, P.O. Box 221200, Chantilly, VA, 20153-1200, US

(73) Assignee: LG ELECTRONICS INC.

(21) Appl. No.: 11/650,413

(22) Filed: Jan. 8, 2007

Related U.S. Application Data
(63) Continuation of application No. 09/967,996, filed on Oct. 2, 2001.

(30) Foreign Application Priority Data
Oct. 6, 2000 (KR) 2000-58667

(51) Int. Cl. G06F 17/00

(52) U.S. Cl. 715/810

(57) ABSTRACT

A method of displaying a list of menus on a screen of a mobile telephone is described. Each menu is represented by a menu icon including at least one of a corresponding text and graphical illustration identifying each menu. The method includes the steps of entirely displaying an initial menu icon representing one of the list of menus on the screen, displaying a portion of the initial menu icon and a second portion of an adjacent menu icon on the screen when a telephone user presses down a navigation key or an arrow key in a direction toward the adjacent menu icon, and entirely displaying the adjacent menu icon on the screen. By using the method according to the present invention, an improved user interface of a top or sub menu list display is achieved by displaying the menu list using a scroll technique and by including a numerical and graphical menu indicator indicating the current menu location in a menu tree.

This is a Continuation of prior application Ser. No. 09/967,996, filed on Oct. 2, 2001, which claims priority to Korean Application No. 2000-58667, filed on Oct. 6, 2000. The entire disclosure of the prior applications is considered as being part of the disclosure of this application and is hereby incorporated by reference herein.

### BACKGROUND

1. Field

The present invention relates to a mobile telephone, and more particularly, to a method of displaying menus on a screen of a mobile telephone using a scroll technique.

2. Background

In general, a mobile telephone of today provides various types of supplemental functions as well as a basic call making/receiving function. Such supplemental functions can be divided into two groups: one group of menu functions and the other group of memory functions. Some of the typical examples of the menu functions are telephone number directories, message management, calling options, voice dialing, electronic organizer, phone manager, and many more. Storing, searching, and modifying telephone numbers are often regarded as typical examples of the memory functions.

In order to use any of such menu functions and/or memory functions, some mobile telephones additionally include a menu key for accessing to the menu or bar functions, a search key for searching a telephone number, and/or a navigation key for various uses. When a user selects a menu from a menu list by pressing down a menu key or a navigation key of a mobile telephone, the LCD (liquid crystal display) of the mobile telephone displays a text or graphic corresponding to the selected menu. The old mobile telephones displayed only selected menus, and the user was able to view and select a desired menu by using the up and down keys.

FIG. 1 is a typical system block diagram of a mobile telephone. As it is shown in FIG. 1, the mobile telephone includes a controller 10, a radio data processor 20, a voice input/output element 30, a display element 40, a memory 50, a key input element 60, and a power supply element 70. The controller 10 controls each part of the mobile telephone, and the radio data processor 20 receives/transmits the data from/to a base station. The voice input/output element 30 inputs the user's voice signal and outputs the voice signal of the other party. Next, the display element 40 (i.e., LCD) displays various states of the telephone and search information, and the memory 50 stores data for various programs and many more. The key input element 60 inputs various commands for searching a desired number or information, and the power supply element 70 provides required electricity to each part of the telephone.

FIG. 2 illustrates sample LCD displays of a mobile telephone showing its menu configuration according to the related art. When a user accesses the top menu list by pressing a menu key or navigation key, the screen shown in FIG. 2A will be displayed on the LCD. It initially displays top menus for Phone Directory (1), Messages (2), and Call Options (3). Each top menu includes a corresponding text and picture indicative of each menu. The screen showing the top menu list further includes the order number (1,2, and 3) of each top menu below each picture and arrow signs (←,→) for displaying other top menus not shown in the previous screen. Since the LCD can show only a limited number of top menus, FIG. 2B can be displayed using up/down keys of the mobile telephone.

When the user selects a desired top menu from the top menu list, a sub menu list of the selected top menu will be displayed as shown in FIG. 3. FIG. 3A illustrates a sub menu list of the Phone Directory top menu and an Outgoing Numbers sub menu. Similarly, FIG. 3.B illustrates a sub menu list of the Messages top menu and an Incoming Messages sub menu. As it is shown in both figures, the sub menu list of a top menu (Phone Directory or Messages) shows each sub menu title with a corresponding order number. Since the sub menu list displays only the sequence number of each sub menu, a user is not able to know the total number of all the sub menus. In addition, the user must press down the sequence number of a desired top or sub menu in order to select the menu. These will greatly inconvenience a mobile telephone user.

### SUMMARY OF THE INVENTION

Accordingly, the present invention is directed to a method of displaying menus on a screen of a mobile telephone that substantially obviates one or more problems due to limitations and disadvantages of the related art.

An object of the present invention is to provide a method of displaying menus on a screen of a mobile telephone that displays adjacent menus and enables a user to select a desired menu using a scroll technique.

Another object of the present invention is to provide a man machine interface (MMI) to a user by including a graphical and numerical indicator indicating which menu is currently being displayed among the menu list.

Another object of the present invention is to provide a method of displaying menus on a screen of a mobile telephone that provides an improved user interface of the mobile telephone by including a numerical and graphical representation indicative of the location of the current item selected in a menu tree.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of displaying a list of menus on a screen of a mobile telephone, each menu being represented by a menu icon including at least one of a corresponding text and graphical illustration identifying each menu, the method includes the steps of entirely displaying an initial menu icon representing one of the list of menus on the screen; displaying a first portion of the initial menu icon and a second portion of an adjacent menu icon on the screen when a telephone user presses down a navigation key or an arrow key of the mobile telephone in a direction toward the adjacent menu icon; and entirely displaying the adjacent menu icon on the screen. The screen further displays a current menu indicator indicating a current menu among the list of menus, the current menu being currently displayed on the screen.

In another aspect of the present invention, A method of displaying a list of menus on a screen of a mobile telephone, each menu being represented by a menu icon including at least one of a corresponding text and graphical illustration identifying each menu, the method including the steps of displaying the list of menus on the screen in rows or columns with a cursor being placed at an initial menu icon being one of the list of menus; displaying the list of menus on the screen with the cursor being placed between the initial menu icon and an adjacent menu icon when a telephone user presses down a navigation key or an arrow key of the mobile telephone in a direction toward the adjacent menu icon; and displaying the list of menus on the screen with the cursor being placed at the adjacent menu icon. Similarly, the screen further displays a current menu indicator indicating a current menu currently being displayed on the screen among the list of menus.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a block diagram illustrating a mobile telephone system according to the background art;

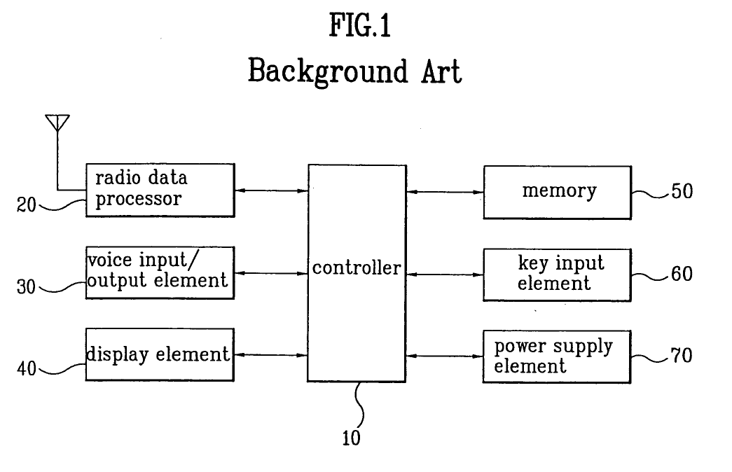

FIG. 2 illustrates top menu displays of a mobile telephone according to the background art;

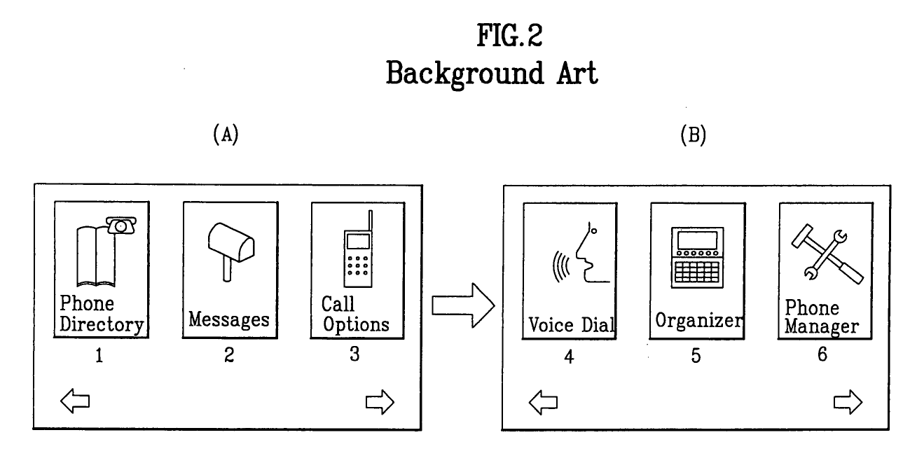

FIG. 3 illustrates sub menu displays of a mobile telephone according to the background art;

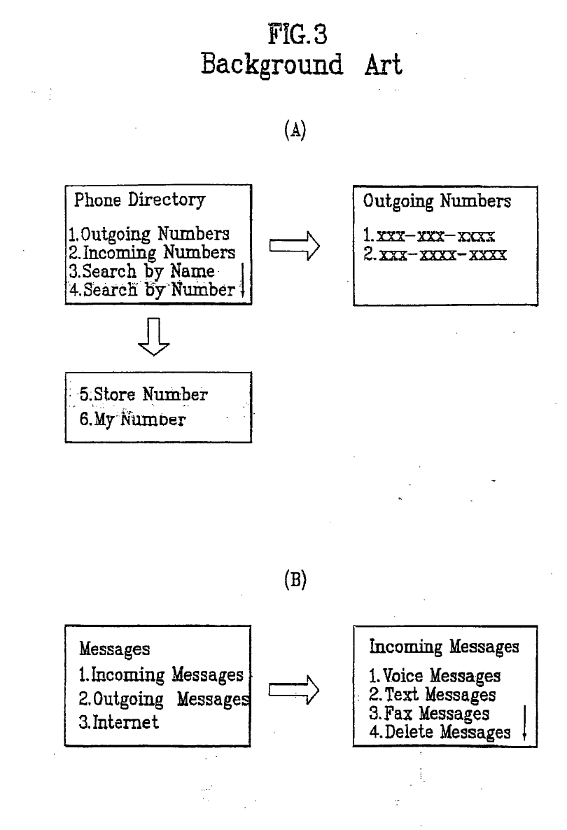

FIG. 4 illustrates displays of a mobile telephone according to a first embodiment of the present invention; and

FIG. 5 illustrates displays of a mobile telephone according to a second embodiment of the present invention.

### DETAILED DESCRIPTION OF THE INVENTION

Reference will now be made in detail to the preferred embodiments of the present invention, examples of which are illustrated in the accompanying drawings.

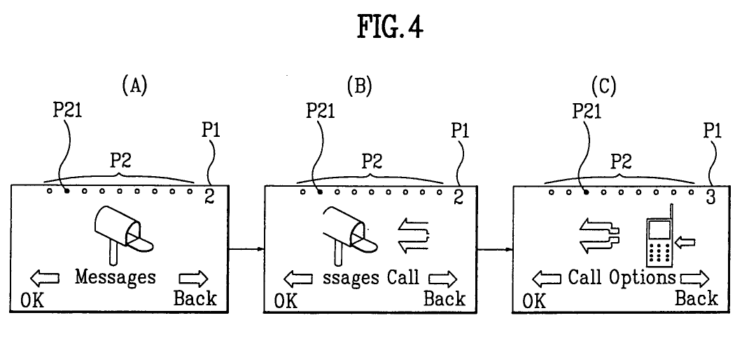

FIG. 4 illustrates displays of a mobile telephone according to a first embodiment of the present invention. It includes a first display (FIG. 4A) illustrating a Message menu, an intermediate display (FIG. 4B) showing both parts of the Messages menu and its Call Option menu adjacent to the Messages menu, and finally a third display entirely showing the Call Option menu. A telephone user must scroll in order to move from FIG. A to FIG. C or from FIG. C to FIG. A by pressing a proper key. Each display shown in FIG. 4 includes a top page number P1 indicating the order number of a top menu currently being displayed, a plurality of boxes P2 indicating the total number of the existing top menus, and a blinking box P21 indicating which top menu among all the existing top menus is being currently being displayed.

In other words, the screen initially displays a Message menu having a graphical illustration and a text as shown in FIG. 4A. When the user presses down a navigation key or enters a top menu number in order to move to a Call Option top menu adjacent to the initial menu, the screen displays the intermediate figure (FIG. 4B) including both of the right half portion of the Message top menu and the left half portion of the Call Options top menu. When the user presses down the navigation key or enters the top menu number again to move to the next menu, the screen will display the entire Call Option top menu. Even though FIG. 4 illustrates the menu scrolls in a left-right direction only as an example, the user driven menu scrolls can be performed in the up/down or diagonal directions as well.

Each of FIG. 4A, FIG. 4B, and FIG. 4C includes the sequence number P1 of a current top menu being displayed, a plurality of boxes P2 indicating the total number of the top menus, a blinking box P21 indicating the current top menu being displayed. For example, the Message menu being displayed in FIG. 4A and FIG. 4B is a second top menu among a total of nine top menus. Therefore, P1 indicates 2, and there are nine boxes P2 indicating the total number of the top menus. In addition, the second box is blinking since the Message menu is a second top menu. The blinking box P21 and other boxes indicating a current top menu are not limited to what is shown in FIG. 4. They can be shown in a different form or color.

In addition, when it is desired to move to a top menu not adjacent to the current top menu, the user can simply press down a key corresponding to the sequence number of the desired top menu. In this case, the screen will not display an intermediate transitional figure. Instead, it will directly display an entire requested top menu.

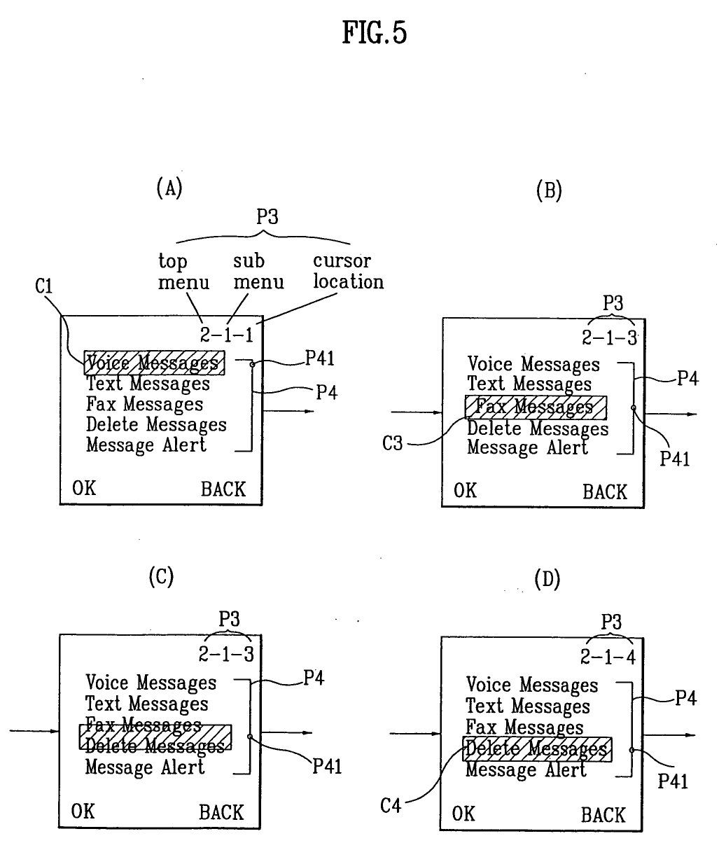

FIG. 5 illustrates displays of a mobile telephone according to a second embodiment of the present invention. Once a desired top menu and a first sub menu are selected from FIG. 4, the screen of the mobile telephone will display the second sub menu list of the selected first sub menu as shown in FIG. 5A. A cursor moves up and down in order to select a desired sub menu. When a user presses a key to move a cursor from an original sub menu to an adjacent sub menu (from C3 to C4), the cursor includes the bottom half of the original sub menu text (Fax Messages) and the top half of the adjacent sub menu text (Delete Messages) as shown in FIG. 5C. If the user presses the key to move the cursor again toward the adjacent sub menu text C4, the cursor will indicate only the adjacent sub menu text (Delete Messages) as shown in FIG. 5D.

In addition, each figure of FIG. 5 has a set of numerals P3, each of which represents the current top menu number, current sub menu number, and current cursor location. For example, each numeral of 2-1-3 represents a second top menu (Messages), a first sub menu (Incoming Messages) of the second top menu selected, and a third item (Fax Messages) of the first sub menu of the second top menu currently being selected by the cursor. Dashes are inserted between the numerals of P3 in order to distinguish each of them. By using the set of numerals P3, the user can see which top menu and/or sub menu he or she is currently viewing in a more compact manner. Therefore, the user is able to access to any desired menu even without viewing the menu list.

Furthermore, each display shown in FIG. 5 includes a bar P4 having a length indicative of the total number of the items included in a sub menu. A point indicator P41 located on the bar P4 represents the current location of the cursor. For example, let's assume that there are five items of a Messages sub menu as shown in FIG. 5A and the length of the bar P4 is one inch. If the cursor is currently on the Fax Messages item (third item) as shown in FIG. 5A, the distance between the point indicator P41 and the top end of the bar P4 can be ½ inch.

In conclusion, an improved user interface of a top menu list display is achieved by displaying and selecting a top menu with a scroll technique and by including a numerical and graphical menu indicator indicative of the current menu location in a menu tree. Similarly, the item list display of a selected sub menu includes a cursor scrolling up and down for selecting a desired item in a friendly manner, and it also includes a numerical and graphical presentation indicative of the current cursor location in a menu tree.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method for controlling a mobile telephone, comprising:
assigning a predetermined key of a keypad to each of a plurality of first-level menus; and
displaying a first icon with text for one of the first-level menus when a corresponding key of the keypad is pressed by a user, said first icon including an illustration for said one of the first-level menus.

2. The method of claim 1, wherein the illustration is a graphic illustration.

3. The method of claim 1, further comprising:
displaying an arrow with said first icon and text,
wherein the arrow indicates a scrolling direction for displaying a second icon for another one of the first-level menus.

4. The method of claim 3, wherein the scrolling direction is a horizontal direction.

5. The method of claim 3, further comprising:
simultaneously displaying a portion of said first icon and a portion of said second icon in response to depression of a navigation key, wherein depression of the navigation key causes the second icon to move in a direction opposite to the direction of the arrow.

6. The method of claim 1, further comprising:
displaying a first indicator indicative of a location of said one of the first-level menus among the first-level menus.

7. The method of claim 6, wherein the first indicator comprises a plurality of boxes arranged in a predetermined sequence, each of said boxes corresponding to a respective one of the first-level menus.

8. The method of claim 7, further comprising:
highlighting the box which corresponds to said one of the first-level menus assigned to the pressed key of the keypad.

9. The method of claim 6, wherein the first indicator is provided horizontally across a screen of the mobile telephone.

10. The method of claim 6, wherein at least one of the first-level menus includes a number of second-level menus.

11. The method of claim 10, further comprising:
displaying a second indicator indicative of a total number of the second-level menus when said at least one of the first-level menus is selected.

12. The method of claim 11, wherein the second indicator provides a vertical indication of the total number of second-level menus.

13. The method of claim 10, further comprising:
displaying a second indicator indicative of a location of the second-level menus when said at least one of the first-level menus is selected.

14. The method of claim 13, wherein the second indicator is provided vertically on a screen of the mobile terminal.

15. The method of claim 1, further comprising:
displaying a first indicator indicative of a total number of the first-level menus.

16. The method of claim 15, wherein the first indicator comprises a plurality of boxes arranged in a predetermined sequence, each of said boxes corresponding to a respective one of the first-level menus.

17. The method of claim 16, further comprising:
highlighting the box which corresponds to said one of the first-level menus assigned to the pressed key of the keypad.

18. The method of claim 15, wherein the first indicator is provided horizontally across a screen of the mobile telephone.

19. The method of claim 15, wherein at least one of the first-level menus includes a number of second-level menus.

20. The method of claim 19, further comprising:
displaying a second indicator indicative of a total number of the second-level menus when said at least one of the first-level menus is selected.

21. The method of claim 20, wherein the second indicator provides a vertical indication of the total number of second-level menus.

22. The method of claim 19, further comprising:
displaying a second indicator indicative of a location of the second-level menus when said at least one of the first-level menus is selected.

23. The method of claim 22, wherein the second indicator is provided vertically on a screen of the mobile terminal.

24. The method of claim 1, wherein the pressed key of the keypad is a number.

25. The method of claim 24, further comprising:
displaying the number of the pressed key with the first icon and text.

26. The method of claim 1, further comprising:
displaying a list of second-level menus when the first icon is selected; and
displaying a plurality of sequence numbers with the list of sub-menus, wherein a first sequence number corresponds to the first-level menu of the first icon and a second sequence number corresponds to one of the second-level menus in the list.

27. The method of claim 26, wherein when the first-level menu assigned to the pressed key is selected, then the second-level menu corresponding to the selected first-level menu is displayed vertically on a screen of the mobile terminal.

28. A method for controlling a mobile telephone, comprising:
selecting a numeric key of a keypad corresponding to one of a plurality of first group of menus; and
displaying a first icon with text for one of the first group of menus based on the selection of the numeric keypad, said first icon including an illustration for said one of the first group of menus;
displaying a first indicator indicative of a location of the selected menu among the first group of menus, wherein when the first group menu is selected, a group of second menus corresponding to the selected first group menu is displayed vertically on a screen of the mobile terminal; and
displaying a second indicator indicative of a location of the group of second menus when said first group menu is selected.

29. The method of claim 28, wherein the first indicator is a horizontal indicator of the location of the selected menu.
